(19) United States
(12) Patent Application Publication
(10) Pub. No.: US 2026/0021837 A1
(43) Pub. Date: Jan. 22, 2026

(54) MOBILE SENSOR-BASED RAILWAY CROSSING SAFETY DEVICE

(71) Applicant: Rowan University, Glassboro, NJ (US)

(72) Inventors: Charles D. MCGLYNN, Williamstown, NJ (US); Hong ZHANG, Glassboro, NJ (US); Joseph S. DIORIO, Williamstown, NJ (US)

(21) Appl. No.: 19/322,401

(22) Filed: Sep. 8, 2025

Related U.S. Application Data
(63) Continuation of application No. 17/297,277, filed on May 26, 2021, now abandoned.
(60) Provisional application No. 62/981,897, filed on Feb. 26, 2020.

(51) Int. Cl. B61L 29/24; G08B 7/00

(52) U.S. Cl. CPC B61L 29/246; B61L 29/243; G08B 7/00

(57) ABSTRACT

A device for detecting an approaching train at a roadway railway crossing and providing an intervention for avoiding a collision that avoids the need for crossing site approval, installations, etc. and associated hardware and installation costs. The device may be configured as a stand-alone device, as an accessory matable to a motor vehicle (e.g., via an OBD II port), or may be fully integrated into the motor vehicle. The device includes a microphone for receiving an ambient audio signal, and processes the audio signal to determine whether a train is present. If so, the device may provide an audible and/or visual warning signal to a vehicle driver, via the device itself or via components of the motor vehicle. In certain other embodiments, the device is configured to provide a control signal causing operation of braking, engine, steering or other vehicle systems to avoid a collision.

### CROSS-REFERENCE TO RELATED APPLICATION

This application claims the benefit of priority, under 35 U.S.C. § 119(e), of U.S. provisional patent application No. 62/981,897, filed Feb. 26, 2020, the entire disclosure of which is hereby incorporated herein by reference.

### FIELD OF THE INVENTION

The present invention relates generally to railway crossing safety devices, and more particularly, to a mobile system, device and method for detecting an approaching train at a roadway railway crossing, and for providing a suitable intervention, such as issuance of an alert to a person at-risk of associated harm, such as a driver of a motor vehicle about to traverse the railway crossing.

### DISCUSSION OF RELATED ART

Today, at-grade railway crossings, at which locomotive train tracks cross automobile roadways, are common. These railway crossings pose an accident risk to train passengers, vehicle passengers/drives, pedestrians, bicyclists that may seek to cross railroad tracks at the same time that a locomotive seeks to cross the roadway, and the risk is relatively greater with increased train speeds, as is common, because of the associated difficulties of avoiding an oncoming train once spotted.

Warning devices are in use for avoiding railroad incidents/collisions. For example, most of the railroad grade crossings in the United States feature passive signs as the primary means of warning such as: unguarded intersections consisting of pavement markings, stop/yield signs and/or crossbucks.

Additionally, locomotive engine whistles were generally sounded by policy, generally at a distance of a quarter mile from the crossing, to provide a warning to passersby. Now, applicable US laws and/or practices typically require a train's engineer to blow the train's horn when approaching and entering any at-grade railway crossing. However, such soundings may be difficult to perceive with the human ear, particularly at a distance, and/or to discern from other noises, and/or to be recognized for what it is. Further, this accomplishes very little for people with hearing impairments.

By way of additional example, railway crossing gates, which are raised and lowered to obstruct a roadway and prevent/warn against crossing railway tracks, are one or the more common of today's warning system. Such gates were introduced in the 1870's as people ignored, misjudged, or were unable to detect the passive warning signs and train whistles/horns.

It's worth noting, however, that there are over 200,000 railroad at-grade roadway crossings in the United States, and that not all of the crossings have gates (which are expensive and require governmental/regulatory site approvals, suitable funding for purchase and installation, installation work crews, available space, etc.), or are otherwise clearly identified to provide sufficient warning of oncoming trains. Unsurprisingly, insufficient warning of an oncoming train is a leading cause of railroad at-grade crossing collisions. The majority of these accidents occur at unmarked railroad crossings but installing, testing, and maintenance of proper markings at all at-grade railroad crossings is so cost-prohibitive that it has never been seriously considered. Further, railway crossing accidents are expected to increase in view of a trend toward increased ridership and population densities.

Despite the various warning devices and systems that do presently exist, it has been reported that a person or vehicle is struck by a train approximately every 3 hours in the United States alone.

Accordingly, it is desirable to have a system, device and method for detecting an approaching train at a roadway railway crossing, and for providing a suitable intervention, such as issuance of an alert to a driver/passenger of a motor vehicle or other person at-risk of associated harm, and for such a system, device and/or method to provide adequate warning or other intervention in view of an oncoming train without the need for crossing site approval, installations, etc. and associated hardware and installation costs.

### SUMMARY

The present invention provides a system, device and method for detecting an approaching train at a roadway railway crossing and providing adequate intervention in view of an oncoming train. The device is small, relatively inexpensive and mobile/portable, such that it avoids the need for crossing site approval, installations, etc. and associated hardware and installation costs. In certain embodiments, the device is configured as a stand-alone device that may issue an audible and/or visual warning, e.g., to a vehicle driver, bicyclist and/or pedestrian. In other embodiments, the device is configured is configured as an accessory matable to a motor vehicle to provide an audible and/or visual warning, e.g., to a vehicle driver. In certain embodiments, such a device may issue the audible, visual or other warning via components of the motor vehicle. In certain other embodiments, the device is configured is configured as an accessory matable to a motor vehicle, or is partially or fully integrated into the motor vehicle, to provide a suitable warning and/or to provide an intervention (e.g., operation of vehicle brakes, steering, accelerator, engine, etc.) to cause the motor vehicle to be controlled to avoid a collision, for example, in driver-operated, or in autonomous driverless, vehicles.

In an exemplary embodiment, a railway crossing safety device comprises a microphone for capturing ambient sound and providing a corresponding data signal, a processor operatively coupled to the microphone to receive and process the data signal. and an output device operatively coupled to the processor and configured to issue an intervention signal if the processor determines that the data signal indicates that at least a portion of the ambient was produced by a train.

### BRIEF DESCRIPTION OF THE FIGURES

An understanding of the following description will be facilitated by reference to the attached drawings, in which:

FIG. 1 is a perspective view of a railway crossing shown in vehicle including a sensor-based railway crossing safety device in accordance with an exemplary embodiment of the present invention;

FIG. 2 is a perspective view of a stand-alone sensor-based railway crossing safety device in accordance with an exemplary embodiment of the present invention;

FIG. 3 is a plan view of a sensor-based railway crossing safety device configured as an automotive accessory in accordance with an alternative exemplary embodiment of the present invention;

FIG. 4 is a block diagram showing functional components of an exemplary stand-alone sensor-based railway crossing safety device in accordance with an exemplary embodiment of the present invention;

FIG. 5 is block diagram showing functional components of a sensor-based railway crossing safety device configured as an automotive accessory in accordance with an alternative exemplary embodiment of the present invention;

FIG. 6 is a flow diagram illustrating a method of operation of a sensor-based railway crossing safety device in accordance with an exemplary embodiment of the present invention;

FIG. 7 shows a graph of train horn noise intensity vs. distance; and

FIG. 8 shows a table showing exemplary data relating to identification of a train horn audio signature.

### DETAILED DESCRIPTION

It has been recognized that applicable US laws and/or practices typically require a train's engineer to blow the train's horn when approaching an at-grade railway crossing (with exceptions for defined “quiet zones” protected by gates and/or other warning systems). The present invention recognizes that the audible signal produced by the train, such as by the train's horn, are effectively train audio signatures that distinguish them from other ambient sounds, and thus can be used to identify the presence of a nearby (or approaching) train in order to avoid a collision.

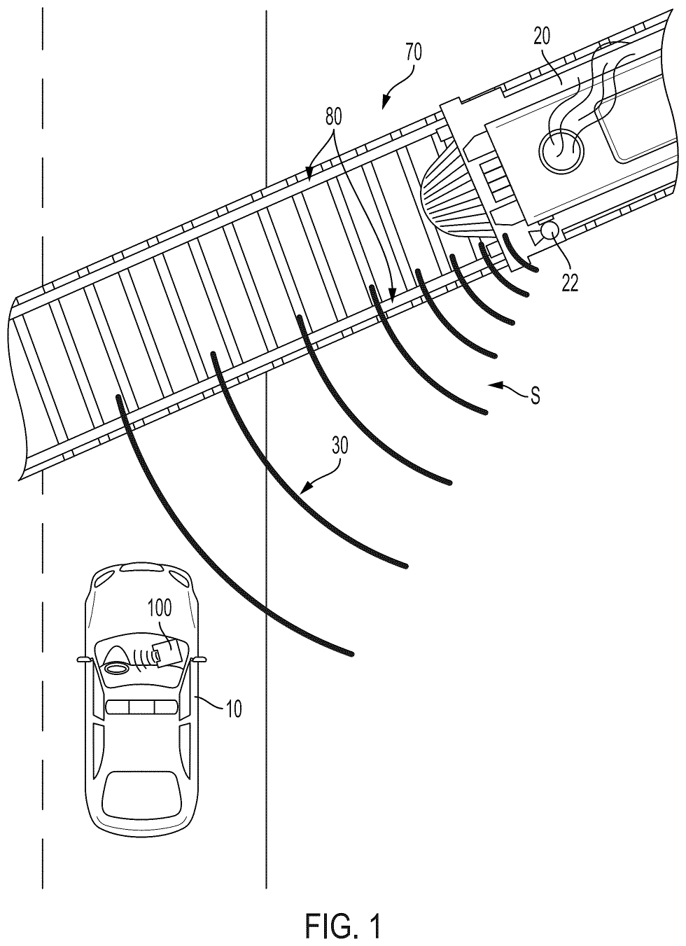

The present invention provides a system, device and method for detecting an approaching train at a roadway railway crossing and providing adequate intervention to avoid a collision with an approaching train. The device is small, relatively inexpensive and mobile/portable, such that it avoids the need for crossing site approval, installations, etc. and associated hardware and installation costs. Accordingly, for example, the device may be placed in/on a vehicle, or may be operatively mated with a vehicle, or may be partially or fully-integrated, e.g., as OEM equipment, with a vehicle. Accordingly, as shown in FIG. 1, a vehicle 10 approaching a railway crossing 70 in which railroad train tracks 80 cross a roadway 30 at grade/the same elevation has a collision risk with a train 20 traveling on the tracks 80 and approaching the same railway crossing 70. In accordance with the present invention, a motor vehicle (or other vehicle) driver or passenger, or pedestrian provided with a mobile sensor-based railway crossing safety device 100 in accordance with the present invention will be provided with a suitable intervention, such as a warning signal to the driver or a control signal operative to control the vehicle, to avoid a collision, as the result of the device's detection of a nearby, e.g., approaching, train. The device is configured to receive an ambient audio signal S produced by the train (e.g., via it's locomotive engine whistle or horn, collectively herein, “horn” 22), to process the audio signal S to determine whether it is indicative of an approaching train, and if so, to provide an appropriate intervention, e.g., in the form of a warning signal or vehicle control signal, as discussed in greater detail below.

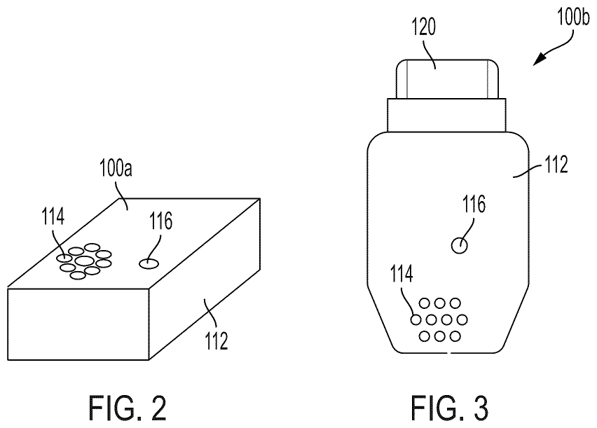

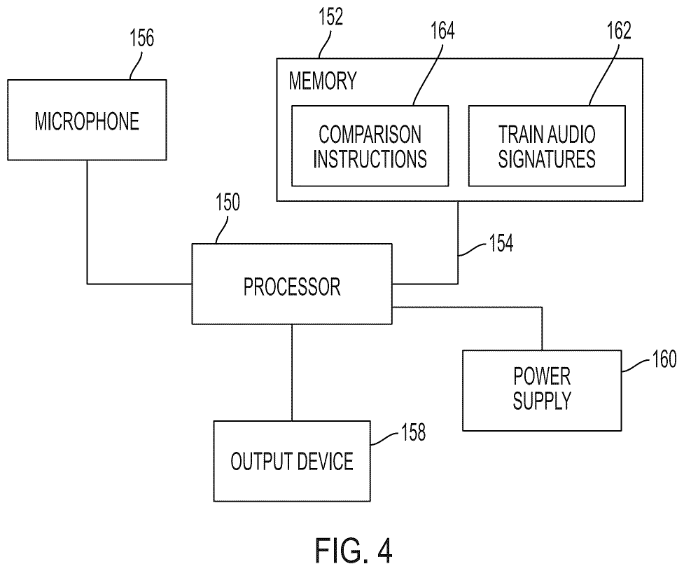

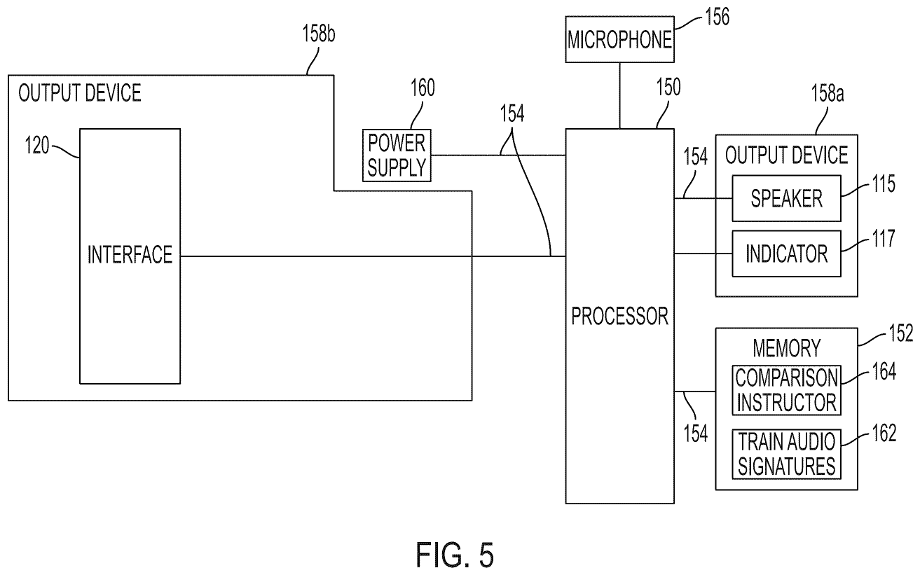

Referring now to FIG. 2, a first exemplary embodiment of a mobile sensor-based railway crossing safety device 100 is shown. In this particular embodiment, the device is configured as a stand-alone mobile sensor-based railway crossing safety device 100a. In this embodiment, the device 100a includes generally, a housing 112 enclosing operative functional components of the device, such that the device is fully self-contained, although in certain embodiments, it may include a power cord and cigarette lighted adapter or other similar power cord for receiving power from an automobile as an alternative to internal batteries housed within the housing. The operative components are discussed below with reference to FIGS. 4 and 5. The housing 112 may define an opening 114 for passing an audio signal produced by the functional components, so that the audio signal may act as a warning/alert to warn a motor vehicle driver, etc. that an oncoming train has been detected. Somewhat similarly, the housing may define an opening for or support an indicator 116, such as an LED, that may be selectively illuminated as part of the functional components to indicate that the device is operable, that an ambient audio signal has been detected and is being processed, and/or that an oncoming train has been detected.

Referring now to FIG. 2, a second exemplary embodiment of a mobile sensor-based railway crossing safety device 100 is shown. In this particular embodiment, the device is configured as a mobile sensor-based railway crossing safety device 100b operatively matable to a motor vehicle to provide an audible and/or visual warning, e.g., to the vehicle's driver. In this embodiment, the device 100b includes generally, a housing 112 enclosing operative components of the device, such that the device is generally self-contained, but the device further includes an interface 120, that allows for operative connection to and data communication with a vehicle's onboard computer (not shown). The interface 120 can be any interface that interfaces with a vehicle, including a Data Link Connector (DLC), such as, for example, an SAE J1962 connector for interfacing with a vehicle's OBD II port. The functional components are discussed below with reference to FIGS. 4 and 5. In such an embodiment, the accessory 100b may receive electrical power from the vehicle's electrical system via the interface 120.

The device 100b may similarly include an opening 114 for passing an audio signal produced and/or an opening for or an indicator 116, for providing an audible and/or visible warning signal to the drive, as described above. Additionally, or alternatively, the device 100b may be partially-integrated into the motor vehicle, such that when the device 100b is coupled to the vehicle's onboard computer, the device is capable of providing output, e.g., via the interface 120, to provide a data communication via the interface acting as a control signal causing controller operation of the vehicle.

In certain embodiments, the control signal may cause operation of equipment of the motor vehicle to provide an audible and/or visible warning signal to the vehicle's driver by actuating hardware of the vehicle itself. For example, this may occur by causing production of an audio signal within the vehicle's cabin, e.g., via audio system loudspeakers, by causing the vehicle's horn to be actuated, by causing lights/lamps/indicators to be illuminated on the vehicle's dashboard or otherwise within the vehicles cabin, etc.

In certain embodiments, the control signal may cause operation of equipment of the motor vehicle to provide an intervention involving operation of the vehicle's safety and/or control systems to cause the vehicle to avoid a collision, by actuating hardware of the vehicle itself. For example, this may occur by causing the vehicle's onboard computer or any of its subsystems to components to operate so as to operate the braking system to cause application of the vehicle's brakes to slow to stop the vehicle, to operate the vehicle's steering system to actively steer the vehicle to avoid the tracks or otherwise avoid collision, to operate the vehicle's engine to cause acceleration to cause the vehicle to traverse the tracks to avoid a collision, or to otherwise control the motor vehicle to cause it to avoid a collision, using control systems of a type generally available in driver-operated, and/or in autonomous driverless, vehicles.

In certain other embodiments, the device 100 (and more particularly its functional components) are fully-integrated into the motor vehicle to provide a suitable warning and/or to provide an intervention (e.g., using control signals in a manner similar to that described above). In such an embodiment, the device 100 need not include its own housing, and need not have a port for interfacing with a vehicle's onboard computer via an OBD II port, but rather may be incorporated into the onboard computer system and/or other conventional components of a motor vehicle, and may for example, use a microphone, power supply, memory, processor, speaker, indicator lamps of the motor vehicle provided for other purposes, or for the dedicated purposes described herein. In this embodiment, for example, the device/functional components may be integrated into an automobile as “original equipment” to provide the inventive functionality and results described herein.

The functional components of the device include a microcontroller, microprocessor or processor (collectively “processor”, such as a Field Programmable Gate Array (FPGA) or any other type of processor or controller.) 150, memory (such as long term storage memory and random access memory (RAM)) 152, communication circuitry 154, a microphone 156, an output device 158, and a power supply 160 for powering the processor 150 and the output device. The memory 152 stores train audio signature data 162 and comparison instructions 164 executable by the processor 150 for processing an audio signal captured by the microphone 156, comparing it to train audio signature data 162 stored in the data store, and providing an output, e.g., a warning signal and/or a control signal, via the output device 158 if the comparison indicates that the captured audio signal is indicative of the presence of a train, or of an approaching train.

By way of example, it may be desirable to use a sensitive, high-sample-rate microphone for the purpose of capturing frequencies/harmonics in a frequency range higher than what a human can typically hear, and the microprocessor may be used to analyze that information to determine if in fact a locomotive has produced them.

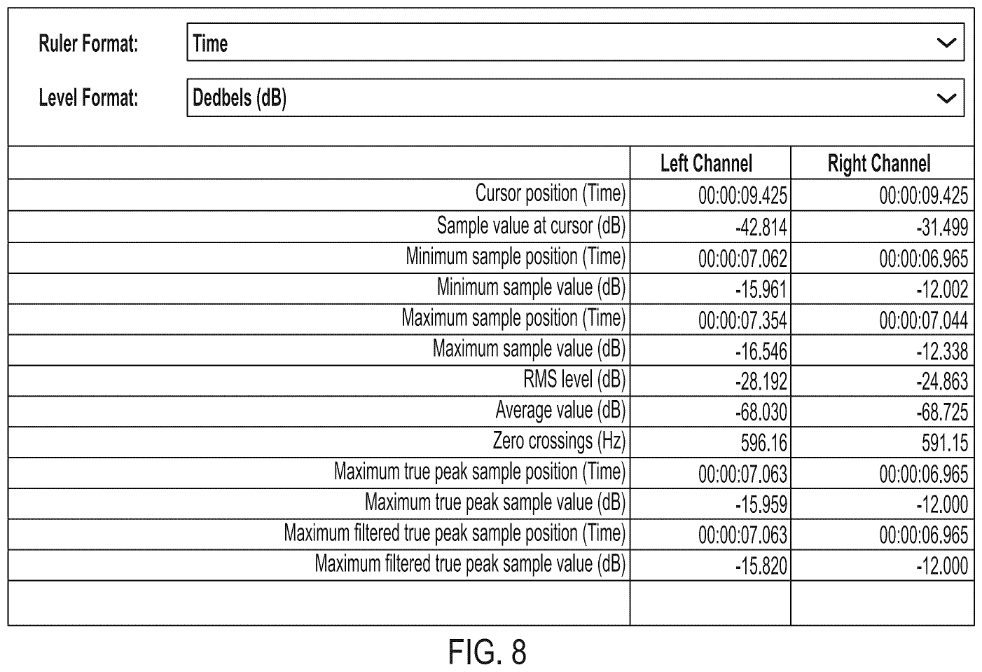

The train audio signatures may have any suitable form. The train audio signatures may be created by recording various train horns, and processing the produced audio signal to identify various parameters that are characteristic of a train horn, and thus usable as a train audio signature for use to distinguish an audio signal that was likely generated by a train's horn from one that was not. FIG. 8 shows a table showing exemplary data relating to identification of a train horn audio signature. Any suitable parameters may be defined for developing a train audio signature determined to be representative of a train. By way of example, various analytical methods may be used to find relevant bands of frequencies, or other characteristics, or to provide a statistically significant prediction through machine learning techniques, as will be appreciated by those skilled in the art.

For example, it is recognized that many trains have horns provided by relatively few suppliers, and that these horns are operative to provide audible horn signals with recognizable characteristics (frequency, loudness, pitch, etc.), and thus have audible characteristics that are effectively audio signatures that distinguish them from other ambient sounds. For example, many of their frequencies are limited to certain bands. For example, the dominant frequencies of Nathan K-5-LA are 311 Hz, 370 Hz, 415 Hz, 494 Hz, 622 Hz, and their harmonics. A database of the frequencies used by the train horns in the market may be stored in the memory of the system as characteristics train audio signature data.

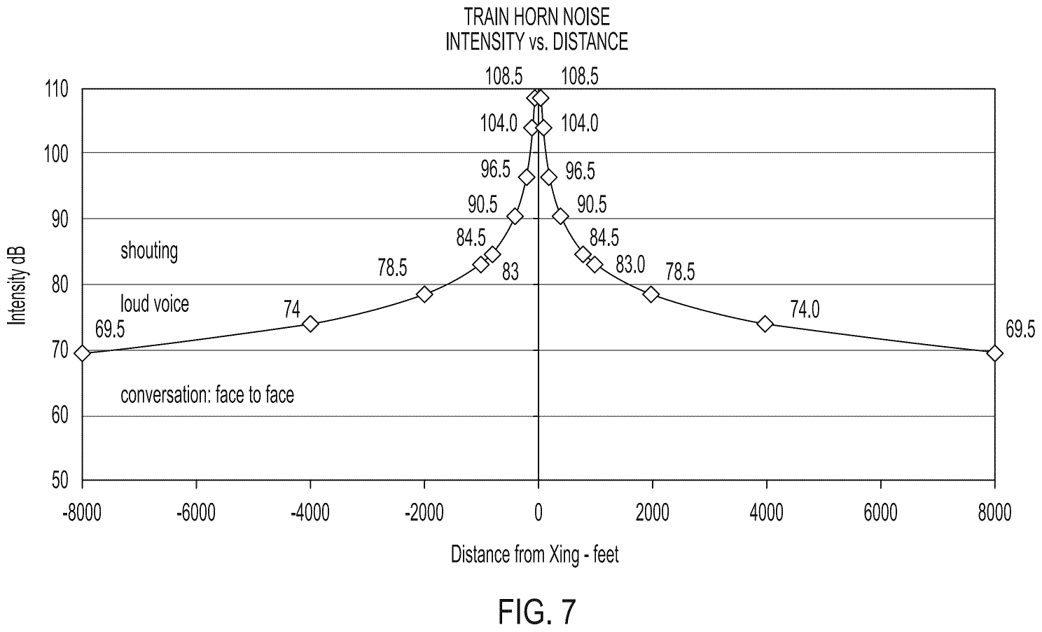

In addition to frequencies, parameters such as a rising sequence, change in intensity/loudness/decibels, or spectral analysis-type signatures may be used to develop train audio signatures that are representative of the presence of a train, or of an approaching train. Any suitable audio signature parameters and data may be generated for this purpose, as will be appreciated by those skilled in the art. FIG. 7 shows a graph of train horn noise intensity (in decibels) vs. distance from a railway crossing (in feet). By way of example, this data may be used to generate a signature involving exceeding of a decibel threshold (e.g., >100 dB), or sequence (increasing from 70 dB to more than 100 dB), or increasing quickly/having a steep change in intensity from 90 to 100 dB), etc. A combination of multiple parameters (e.g., frequency within a certain range and loudness/intensity within a certain decibel range) may also be used to define train audio signatures.

Additionally, it has been recognized that trains are typically required to sound their horns in a specific prescribed pattern when approaching a railway crossing. According to Federal Railroad Administration (RFA), which regulates U.S. railroad safety, all locomotives are required to sound the horns 15˜20 seconds before entering all public grade crossings or from a designated location. The blowing of the horn, or whistle post, is defined in different countries. In the United States, the prescribed whistle post pattern is two long (horn blasts), one short (horn blast), and one long (horn blast). This pattern provides an effective audio signature of a train that can be used to identify an approaching train.

Accordingly, the present invention provides a processor-based sound detection and analysis system to detect and analyze ambient sounds to identify sounds associated with a nearby or approaching train. Although the driver of a vehicle or other passerby may not hear the horn of an approaching train due to cabin/ambient noise, or see the train due to low-visibility weather conditions or darkness, the device of the present invention may capture the horn sound, recognize its frequency, intensity, sound pattern or other characteristics, and warn the driver if necessary.

In certain embodiments, the device may further determine a speed of an approaching train. For example, in such an embodiment, the processor may continuously “listen” to ambient sounds captured via the microphone and periodically sample them and/or analyze them. For example, for each of a plurality of predetermined intervals, e.g., every 10 microseconds, the processor may perform a frequency analysis of the captured audio signa and compare the captured frequencies (or other parameters) with the stored train audio signature data (e.g., stored train audio signature frequencies or other parameters).

In one embodiment, if a frequency signature in the captured samples is determined to match a frequency signature of a train audio signature stored in the database, then the processor may then “listen” to captured ambient audio and seek to identify horn patterns, e.g., at relevant bands of frequencies. By comparing the early part of the horn pattern with a stored pattern, the processor can determine whether a train is approaching. By detecting the change of the frequencies, the speed and direction of the train can be estimated using the Doppler effect. If the frequency is increasing, then the train may be determined to be approaching, and the processor may cause a warning signal to be sounded, etc. if the automobile is also moving and heading toward collision is possible.

In the case of the stand-alone mobile sensor-based railway crossing safety device 100a shown in FIG. 2, the power supply 160 may be provided as batteries stored within the housing 112, or as a power cord fixed or removably attached to the housing/processor and having a cigarette lighter adapter for mating with a vehicle's accessory port. Further, the microphone 156 may be hard wired to the housing/processor, or the housing may include a port for attaching a microphone's cable, which may be elongated to allow for placement of the microphone's transducer outside of the passenger cabin of the vehicle 10. The output device 158 may be an audible signal producing device such as a loudspeaker or other audio-producing hardware, or a visible signal producing device, such as an LED or other visual indicator providing a visual indication.

FIG. 5 is a schematic block diagram showing functional components of a sensor-based railway crossing safety device configured as an automotive accessory 100b in accordance with an alternative exemplary embodiment of the present invention. It should be understood that a fully-integrated device in accordance with the invention has similar components to those shown in FIGS. 4 and 5, but need not have the precise housing/port/output device structures shown in the examples of FIGS. 2 and 3, as the components may be implemented throughout the vehicle, including its on-board computer system.

Referring now to FIG. 5, the device 100/100b again includes a processor 150, memory 152, communication circuitry 154, microphone 156, output device 158a, 158b, and power supply 160. The memory 152 again stores train audio signature data 162 and comparison instructions 164 executable by the processor 150. In part, the output device 158b includes a speaker 115 and indicator/LED 116/117 for provide audible and visual warning signals to the driver, etc., in a manner similar to that described above.

Additionally, in this embodiment, the output device 158b further includes an interface 120 for communicating data with a vehicle's on-board computing system, for delivering warning signals and/or control signals for controlling vehicle hardware and/or operation, as described above. In the case of the accessory device 100b of FIG. 3, the interface 120 may include a SAE J1962 connector for interfacing with a vehicle's OBD II port. In certain embodiments, the processor 150 may be coupled to the interface 120 through an SAE J1850 vehicle interface, or a CAN (Controlled Area Network) vehicle interface. The J1850 vehicle interface includes the hardware and/or software that allow the processor 150 to communicate with a vehicle equipped with J1850 communication protocol. The CAN vehicle interface includes the hardware and/or software that allow the processor to communicate with a vehicle equipped with CAN communication protocol. Additionally, an ISO 9141-2 vehicle interface may be included that includes the hardware and/or software that allow the processor 150 to communicate with a vehicle equipped with ISO 9141-2 communication protocol. A person skilled in the art will recognize that other vehicle communication protocols may also be utilized and that their respective interfaces are well within the embodiments of this invention. Any communication protocol can be utilized to communicate with the vehicle.

In the case of a device 100 fully integrated into a vehicle, the interface 120 need not include a SAE J1962 connector for interfacing with a vehicle's OBD II port, but rather may be operatively connected to a communication bus of the vehicle's on-board computing system, e.g., via a printed circuit board, so that the device 100 can cause output of control signals for controlling vehicle hardware and/or operation, e.g., to provide warning signals to a vehicle driver and/or to control operation of vehicle systems to provide an active intervention for avoiding a collision with an oncoming train.

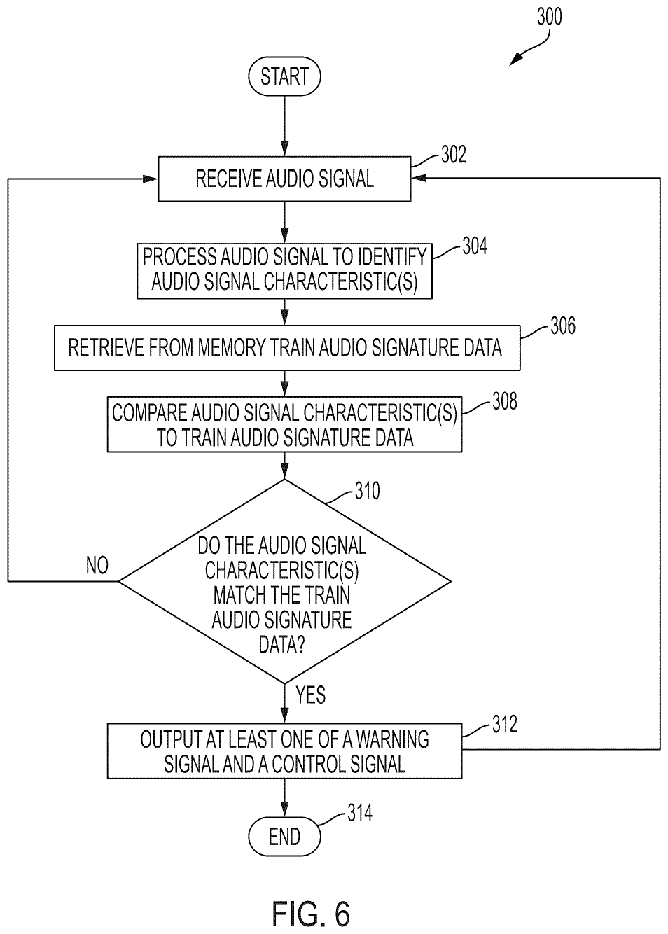

FIG. 6 is a flow diagram 300 illustrating a method of operation of a sensor-based railway crossing safety device in accordance with an exemplary embodiment of the present invention. As shown in FIG. 6, the method begins with receipt of an audio signal at the device 100, via the microphone 156.

The method further includes processing the audio signal to identify audio signal characteristics, as shown at 304. For example, this may involve operation of the processor 150 under control of comparison instructions 164 stored in the memory 152 of the device, which may cause the processor 150 to process the audio signal by comparing and matching signals/signal characteristics using various analysis techniques to identify audio signal characteristics such as horn frequency, intensity, and other train acoustics. Various analysis techniques are well-known in the art and beyond the scope of the present invention, and thus are not discussed in greater detail herein.

The method further includes retrieving from memory train audio signature data, as shown at 306. This may involve retrieval of parameters or other data stored as train audio signature data 162 in the memory 152 of the device. Notably, this step further includes use of static or hard-coded parameters that may be embedded into the comparison instructions such as 330 Hz, a frequency of widely used horns available in the marketplace (Model 56 manufactured by Federal Signal Corporation, operated at 330 Hz with a sound level output of 108 dB at 3.5 meters away). By way of example the train audio signature data may include data representing a frequency, frequency range, spectral pattern, minimum intensity, duration, or intensity pattern, such as the long/long/short/long intensity pattern described above. The exact length of any individual “long” or “short” horn blast may vary, as it is typically determined by manual horn operation by the train's driver/engineer. Similarly the sound level/intensity may also vary, as it is subject to the distance of the train from the device. Nevertheless, the device may be configured to detect and determine a relative pattern of long/long/short/long, with pauses in between.

The processor 150, under control of the comparison instructions 164, then compares one or more audio signal characteristics derived from the audio signal captured by the microphone 156 to train audio signature data, as shown at 308. It is then determined whether the observed audio signal characteristics match the train audio signature data, as shown at 310. Whether there is a match may be determined by any suitable algorithm or computation, and an exact match may not be required. Rather, determination of a match involves meeting of criteria or determination of similarity sufficient to conclude that the audio signal is that of a train, such that action is taken with the recognition that a train is present. Any suitable signal processing techniques may be used for doing so, as will be appreciated by those skilled in the art. By way of example, a match may be determined by comparing the captures audio signal to the database and concluding that there is a match if a predetermined accuracy threshold has been met.

If it is determined that there is no match at 310, then the method flow returns to 302, and a next audio signal is captured/received and analyzed as described above. This may continue, for example, continuously while a vehicle is operational.

If, however, it is determined that there is a match at 310, then the method flow continues to 312, and the device provides a suitable output. For example, the output may be issuance of an audible alarm tone via a loudspeaker 115 output device 158. By way of alternative example, the output may be issuance of a visible signal by illumination of an LED or other indicator 117 output device 158. By way of alternative example, the output may be transmission of a control signal via the interface 120 to an on-board computing system of a vehicle. The control signal may be operative to cause a loudspeaker of the vehicle to sound, or an LED/indicator of the vehicle (e.g., any of the vehicle's existing dashboard lights, or a special-purpose light) to be illuminated to provide a warning to the vehicle's driver. By way of alternative example, the control signal may cause multiple dash lamps/indicators to flash when the device detects that it is within 1000 meters of an approaching train. Alternatively, the control signal may be operative to cause a braking system to operate to decelerate the vehicle, and engine system to operate to accelerate the vehicle, a steering system to operate to redirect a direction of travel of the vehicle, or another control signal configured to otherwise provide input to systems of the vehicle that may be operated to avoid a collision with the approaching train.

As discussed above, the comparison and determination of matches may involve comparison of only one parameter (e.g., frequency, frequency range, frequencies, intensity/loudness, pattern, etc.), or may involve comparison of multiple parameters (e.g., if there's a match of a frequency signature in a captured sample, then a comparison is made to find a match of a horn pattern). Additionally, the comparing may involve comparing the early part of the horn pattern with a stored pattern, and the matching step may further involve determining whether a train is approaching (an approaching train being a match, a receding train being a mismatch, from the perspective of issuing a warning signal or control signature for an intervention.

Method flow may then return to 302, and a next audio signal is captured/received and analyzed as described above. This may continue, for example, continuously while a vehicle is operational. Alternatively, for example, the method may simply end as shown at 314.

It should be noted that the device described herein is described with reference to capture and analysis of horn/whistle signal characteristics for illustrative purposes only, and that capture and analysis of any other acoustic signals that are characteristic of and useful for identifying nearby trains/locomotive is within the scope of the present invention.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A railway crossing safety device comprising:
a microphone for capturing ambient sound and providing a corresponding data signal;
a processor operatively coupled to the microphone to receive and process the data signal; and
an output device operatively coupled to the processor and configured to issue an intervention signal different from a signal derived from an ambient sound if the processor determines that the data signal indicates that at least a portion of the ambient sound was produced by a train;
wherein the output device comprises an interface configured for operative connection to and data communication with a vehicle's onboard computer system via a data port of the vehicle, the interface being configured to be operatively connected to a communication bus of the vehicle's onboard computing system.

2. The railway crossing safety device of claim 1, further comprising:
a memory operatively coupled to the processor, the memory storing train audio signature data.

3. The railway crossing safety device of claim 1, further comprising:
a memory operatively coupled to the processor, the memory storing train audio signature data and comparison instructions executable by the processor to process the data signal and determine whether at least one characteristic of the data signal matches stored train audio signature data.

4. The railway crossing safety device of claim 3, further comprising:
one of an audible signal producing device and a visual signal producing device operatively connected to the processor;
wherein the comparison instructions further comprise instructions executable by the processor to cause the audio signal producing device to produce an audible warning signal or visual signal producing device to produce a visual warning signal as the intervention signal.

5. (canceled)

6. (canceled)

7. (canceled)

8. The railway crossing safety device of claim 3, wherein the comparison instructions further comprise instructions executable by the processor to cause transmission via the interface of a control signal operable to cause production of at least one of an audible warning signal and a visible warning signal via a motor vehicle component as the intervention signal.

9. The railway crossing safety device of claim 3, wherein the comparison instructions further comprise instructions executable by the processor to cause transmission via the interface of a control signal operable to control operation of at least one of a braking system, a steering system, an acceleration system and a passenger restraint system of a motor vehicle as the intervention signal.

10. (canceled)

11. (canceled)

12. The railway crossing safety device of claim 1, wherein the microphone is a sensitive microphone capable of capturing audio signals having a frequency above 20 kHz.

13. The railway crossing safety device of claim 1, wherein the train audio signatures data identifies at least one of a frequency, frequency range, intensity, intensity range and intensity pattern characteristic of train-produced acoustic signals

14. The railway crossing safety device of claim 1, wherein the processor is configured to process the data signal by performing spectral analysis.

15. (canceled)

16. (canceled)

17. The railway crossing safety device of claim 1, wherein the processor is configured to process the data signal to determine whether a train producing a captured audio signal is approaching or receding from the microphone.

18. The railway crossing safety device of claim 1, wherein the processor is configured to provide the intervention signal only if the train is determined to be approaching and not receding.

19. A railway crossing safety device comprising:
a housing;
a processor housed within the housing to receive and process data signals;
a microphone for capturing ambient sound and providing a corresponding data signal, the microphone being disposed outside the housing and being operatively coupled to the processor;
a memory operatively coupled to the processor, the memory storing train audio signature data and comparison instructions executable by the processor to process the data signal and determine whether at least one characteristic of the data signal matches stored train audio signature data; and
an output device operatively coupled to the processor and configured to issue an intervention signal different from a signal derived from an ambient sound if the processor determines that the data signal indicates that at least a portion of the ambient was produced by a train, said output device comprising an interface configured for operative connection to and data communication with a vehicle's onboard computer system, said interface being operatively connected to a communication bus of the vehicle's on-board computing system.

20. The railway crossing safety device of claim 19, wherein said output device further comprises:
an audible signal producing device operatively connected to the processor;
wherein the comparison instructions further comprise instructions executable by the processor to cause the audio signal producing device to produce an audible warning signal as the intervention signal.

21. The railway crossing safety device of claim 19, wherein said output device further comprises:
a visual signal producing device operatively connected to the processor;
wherein the comparison instructions further comprise instructions executable by the processor to cause the visible signal producing device to produce a visible warning signal as the intervention signal.

22. The railway crossing safety device of claim 19, wherein said interface comprises a data link connector.

23. (canceled)

24. (canceled)

25. (canceled)

26. A method for providing a railway crossing safety intervention using a railway crossing safety device comprising a microphone for capturing ambient sound and providing a corresponding data signal, a processor operatively coupled to the microphone to receive and process the data signal, a memory operatively coupled to the processor and storing train audio signature data and comparison instructions executable by the processor to process the data signal and determine whether at least one characteristic of the data signal matches stored train audio signature data, and an output device operatively coupled to the processor and configured to issue an intervention signal if the processor determines that the data signal indicates that at least a portion of the ambient sound was produced by a train, the method comprising:
receiving an ambient audio signal via the microphone and providing a corresponding data signal;
processing the audio data signal to identify audio signal characteristics;
retrieving from the memory train audio signature data, the train audio signature characteristics identifying audio signal characteristics associated with acoustic signals produced by trains;
comparing at least one identified audio signal characteristic to the retrieved train audio signature data comprising a whistle pattern of two long horn blasts, one short horn blast, and one long horn blast, to compare a first part of a horn pattern with a stored horn pattern;
determining whether the at least one identified audio signal characteristic matches at least one train audio signature characteristic; and
outputting an intervention signal comprising at least one of a warning signal that is not derived from an ambient sound and a control signal.

27. The method of claim 26, wherein determining whether the at least one identified audio signal characteristic matches at least one train audio signature characteristic comprises determining whether there is similarity sufficient to conclude that the audio signal comprises an acoustic signal produced by a train.

28. (canceled)

29. (Canceled)

30. (Canceled)

31. (Canceled)

32. (canceled)

33. The method of claim 26, wherein outputting at least one of a warning signal and a control signal comprises issuance of at least one of an audible alarm tone produced via an audible signal producing device of the railway crossing safety device and a visible signal produced via a visible signal producing device of the railway crossing safety device.

34. The method of claim 26, wherein outputting at least one of a warning signal and a control signal comprises issuance of a control signal via an interface of the device to an on-board computer system of a motor vehicle, the control signal being operative to cause issuance of at least one of an audible alarm tone produced via an audible signal producing device of the motor vehicle and a visible signal produced via a visible signal producing device of the motor vehicle.

35. The method of claim 26, wherein outputting at least one of a warning signal and a control signal comprises issuance of a control signal to an on-board computer system of a motor vehicle, the control signal being operative to cause operation of at least one of a braking system of the motor vehicle, a steering system of the motor vehicle, and an acceleration system of the motor vehicle.
